(19) United States
(12) Patent Application Publication
(10) Pub. No.: US 2009/0104536 A1
(43) Pub. Date: Apr. 23, 2009

(54) NEGATIVE ELECTRODE FOR LITHIUM ION SECONDARY BATTERY, METHOD FOR PRODUCING THE SAME, AND LITHIUM ION SECONDARY BATTERY USING THE SAME

(76) Inventors: Yasutaka Kogetsu, Osaka (JP); Kazuyoshi Honda, Osaka (JP); Toshitada Sato, Osaka (JP)

Correspondence Address: MCDERMOTT WILL & EMERY LLP, 600 13TH STREET, NW, WASHINGTON, DC, 20005-3096, US

(21) Appl. No.: 11/916,493

(22) PCT Filed: Jul. 19, 2006
(86) PCT No.: PCT/JP2006/314233

§ 371 Date: Dec. 4, 2007

(30) Foreign Application Priority Data
Jul. 21, 2005 (JP) 2005-211360

(51) Int. Cl. H01M 4/02

(52) U.S. Cl. 429/231.95; 427/78

(57) ABSTRACT

A negative electrode for a lithium ion secondary battery including a current collector and an active material layer carried on the current collector, wherein the active material layer includes an active material represented by the general formula: LiₐSiOₓ where 0.5≦a−x≦1.1 and 0.2≦x≦1.2; and the active material is obtained by vapor-depositing lithium on a layer including an active material precursor containing silicon and oxygen to cause reaction between the active material precursor and the lithium.

### TECHNICAL FIELD

The present invention relates to a lithium ion secondary battery, and more particularly to a negative electrode for use in a lithium ion secondary battery and a method for producing the same.

### BACKGROUND ART

Lithium ion secondary batteries are widely used, for example, as a power source for driving electronic equipment. In lithium ion secondary batteries, as a negative electrode active material, for example, graphite materials are widely preferably used. An average potential during the extraction of lithium from graphite materials is about 0.2 V (vs. Li/Li⁺) and this potential exhibits a relatively flat profile during discharge. Graphite materials are preferable because the battery voltage becomes high and constant for the reasons above. However, since the capacity per unit mass of graphite materials is as small as 372 mAh/g, and the capacity of graphite materials at present has already increased close to a theoretical capacity, a further increase in capacity cannot be expected.

In an attempt to achieve a further increase in the capacity of batteries, studies about various negative electrode active materials have been conducted. For example, as negative electrode active materials having a high capacity, materials capable of forming an intermetallic compound with lithium such as silicon or tin are considered promising. In these materials, however, the crystal structure changes and the volume thereof increases during the absorption of lithium. A large volume change in the active material during charge and discharge causes a failure in contact between the active material and the current collector, and other failures. This disadvantageously results in a shortened charge/discharge cycle life.

In order to solve the problems as described above and improve the charge/discharge cycle life, attempts have been made to partially oxidize silicon so that the volume expansion rate during the absorption of lithium can be reduced. However, since the partial oxidation of silicon increases the irreversible capacity during initial charge and discharge, it may be impossible to make full use of the advantage of high capacity of silicon.

In order to reduce the irreversible capacity during initial charge and discharge, one proposal suggests, for example, that a lithium oxide layer be formed on a silicon oxide thin film formed on a current collector, and further a lithium layer be formed, thereby to supplement the silicon oxide with lithium (See Patent Document 1).

Moreover, in order to increase the battery capacity, another proposal suggests that a first layer mainly composed of carbon be provided on a current collector and then a second layer mainly composed of silicon etc, or others be provided on the first layer (Patent Document 2). Patent Document 2 discloses that the second layer may include, for example, a silicon oxide and lithium, and such a second layer is formed by means of simultaneous vapor deposition of a silicon oxide and lithium.

Patent Document 1: Japanese Laid-Open Patent Publication No. 2003-162997

Patent Document 2: Japanese Laid-Open Patent Publication No. 2002-358954 (Japanese Patent Publication No. 3520921)

### DISCLOSURE OF THE INVENTION

### Problem to be Solved by the Invention

In the negative electrode disclosed in Patent Document 1, a lithium oxide layer is present between the silicon layer and the lithium layer. However, alloying reaction of silicon and lithium will not proceed simply by forming the each layer. Alloying of silicon and lithium will occur after the layers were included in an assembled battery. For this reason, there may be a risk that during alloying of silicon and lithium, the electrolyte is decomposed to generate gas or heat is generated.

In Patent Document 1, since the lithium oxide layer is formed by oxidation-reduction reaction in a solid phase, the lithium oxide layer is thin compared with an oxide coating film formed in a solid-fluid interface in an assembled battery. For this reason, with such a lithium oxide layer, it is difficult to sufficiently reduce the irreversible capacity.

Moreover, since the negative electrode active material layer of Patent Document 1 is formed by a complicated oxidation-reduction reaction, it is difficult to control the amount of oxygen contained in the negative electrode. When the amount of oxygen to react with silicon varies, the irreversible capacity varies greatly. In addition, since a desired amount of oxygen is unclear, an amount of lithium necessary for such an amount of oxygen is also unclear.

In the negative electrode disclosed in Document 2, the second layer is formed by means of simultaneous vapor deposition of a silicon oxide and lithium. However, the reaction resistance of silicon oxide during initial charge is extremely great, and the initial charge requires a considerably long period of time. In other words, in the case where a silicon oxide and lithium are caused to react as a battery reaction, the reaction between the silicon oxide and lithium requires a long period of time because the resistance of silicon oxide is high. As a result, the production efficiency is significantly reduced.

Moreover, in the case where a second layer comprising an oxide and lithium is formed, an amount of lithium necessary for the amount of oxygen is also unclear.

In light of the above, the present invention intends to provide a high capacity lithium ion secondary battery having a shortened initial charge time.

### Means for Solving the Problem

The present invention relates to a negative electrode for a lithium ion secondary battery including a current collector and an active material layer carried on the current collector, wherein

the active material layer includes an active material represented by the general formula: LiₐSiOₓ (where 0.5≦a−x≦1.1 and 0.2≦x≦1.2); and the active material containing silicon and oxygen is obtained by vapor-depositing lithium on a layer including an active material precursor containing silicon and oxygen to cause reaction between the active material precursor and the lithium. The active material layer has cracks throughout the entire layer thereof. It is preferable that a thickness T of the layer including an active material precursor per one face of the current collector is 0.5 μm≦T≦30 μm. It is preferable that a thickness of the active material layer is 0.5 μm to 50 μm.

It is preferable that in the foregoing negative electrode for a lithium ion secondary battery, lithium oxide or lithium carbonate is present on the surface of the active material layer.

Further, the present invention relates to a method for producing a negative electrode for a lithium ion secondary battery comprising steps of: (A) forming a layer including an active material precursor containing silicon and oxygen on a current collector; and (B) vapor-depositing lithium on the layer including an active material precursor to cause reaction between the active material precursor and lithium.

In the foregoing step (B), it is possible that while lithium is vapor-deposited on the layer including an active material precursor, the layer including an active material precursor is heated at 50° C. to 200° C., thereby to cause reaction between the active material precursor and lithium. Alternatively, it is possible that after lithium is vapor-deposited on the layer including an active material precursor, the layer including an active material precursor, on which lithium is vapor deposited, is heated at 50° C. to 200° C., thereby to cause reaction between the active material precursor and lithium.

In the foregoing production method, it is preferable that vapor deposition of the lithium is performed using a vapor deposition method or a sputtering method.

In the foregoing step (B), it is preferable that lithium is vapor-deposited on the layer including an active material precursor containing silicon and oxygen in an atmosphere composed of an inert gas.

The present invention further relates to a lithium ion secondary battery comprising a positive electrode, the foregoing negative electrode, a separator interposed between the positive electrode and the negative electrode, and an electrolyte.

### EFFECT OF THE INVENTION

By vapor-depositing lithium on a layer including an active material precursor containing silicon and oxygen, the lithium is diffused in the active material precursor and the lithium enters the bonding network of silicon and oxygen, the network having blocked the diffusion of lithium. By virtue of the lithium having entered in such a manner, diffusion paths that permit lithium to enter and exit are formed in an atomic level in the surface of the active material containing silicon, oxygen and lithium. As a result, the conductivity of the active material can be improved and the reaction resistance of the active material can be reduced, and thus the initial charge time can be shortened. Furthermore, by adjusting the molar ratio of lithium according to the molar ratio of silicon and oxygen contained in the active material, the reduction in battery capacity can be prevented.

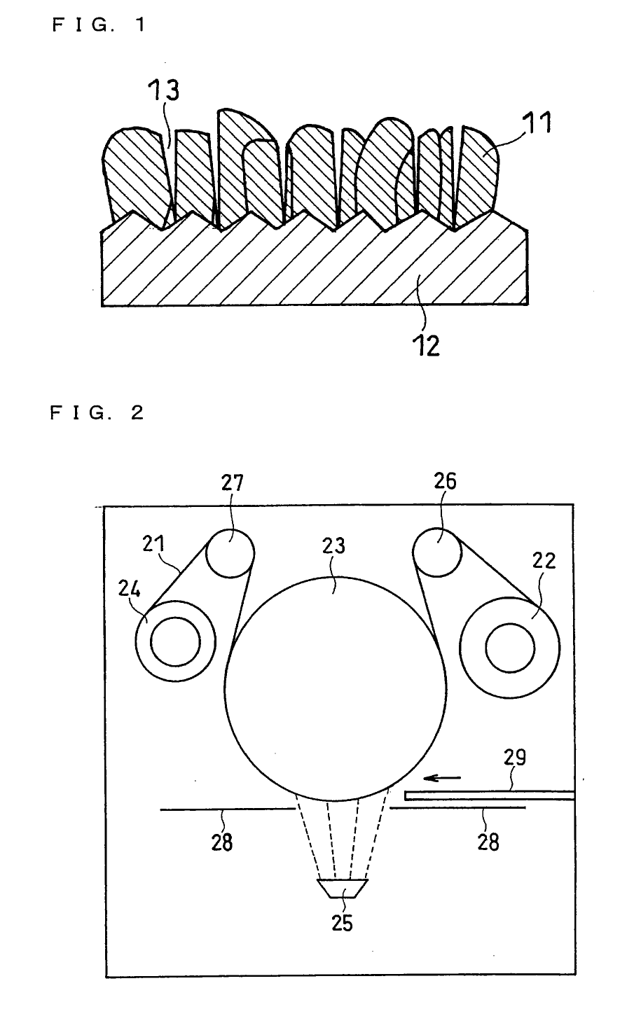

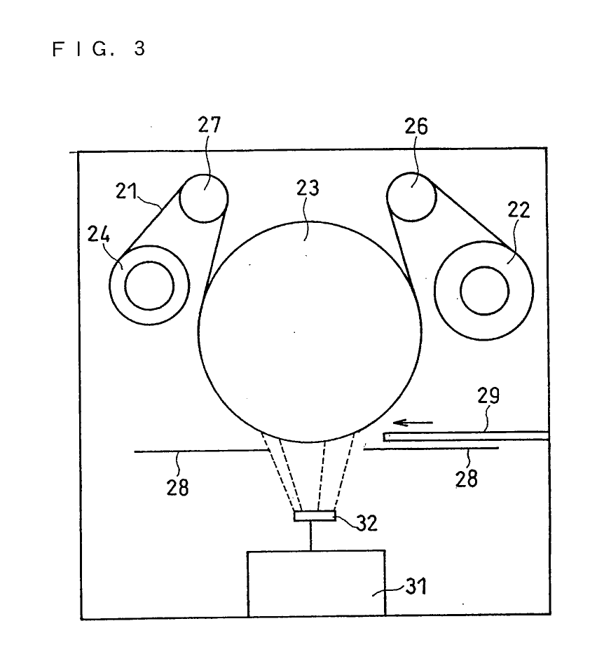

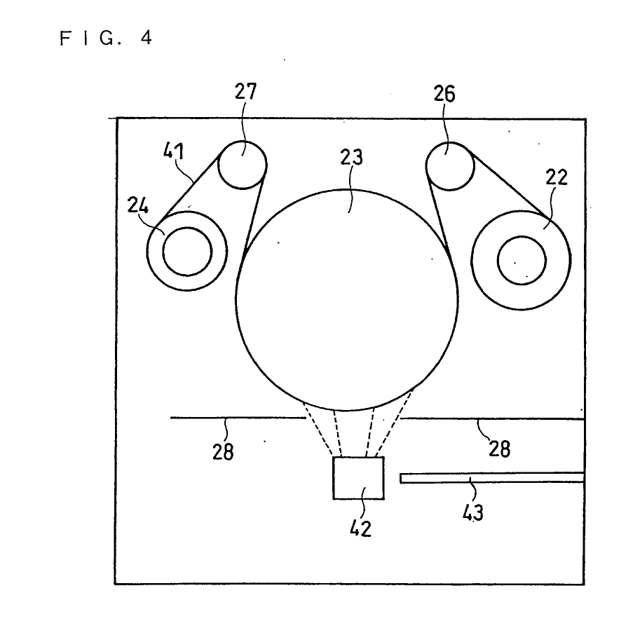

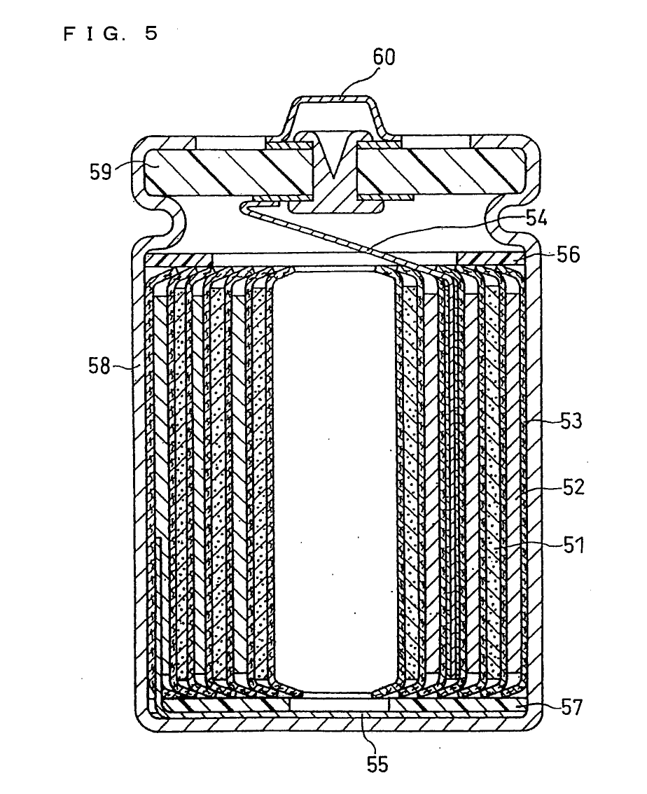

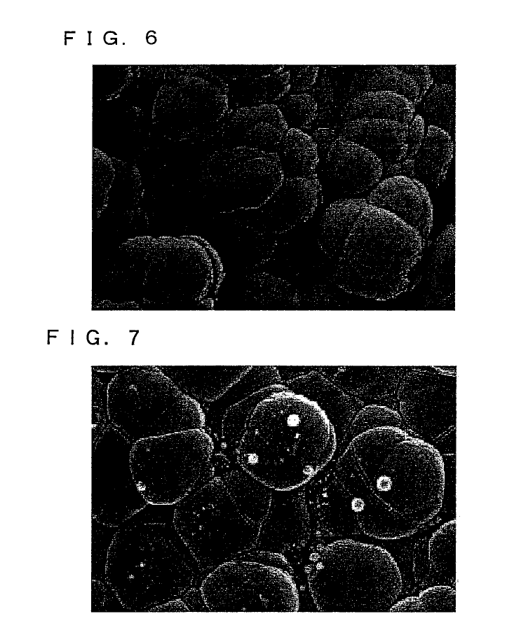

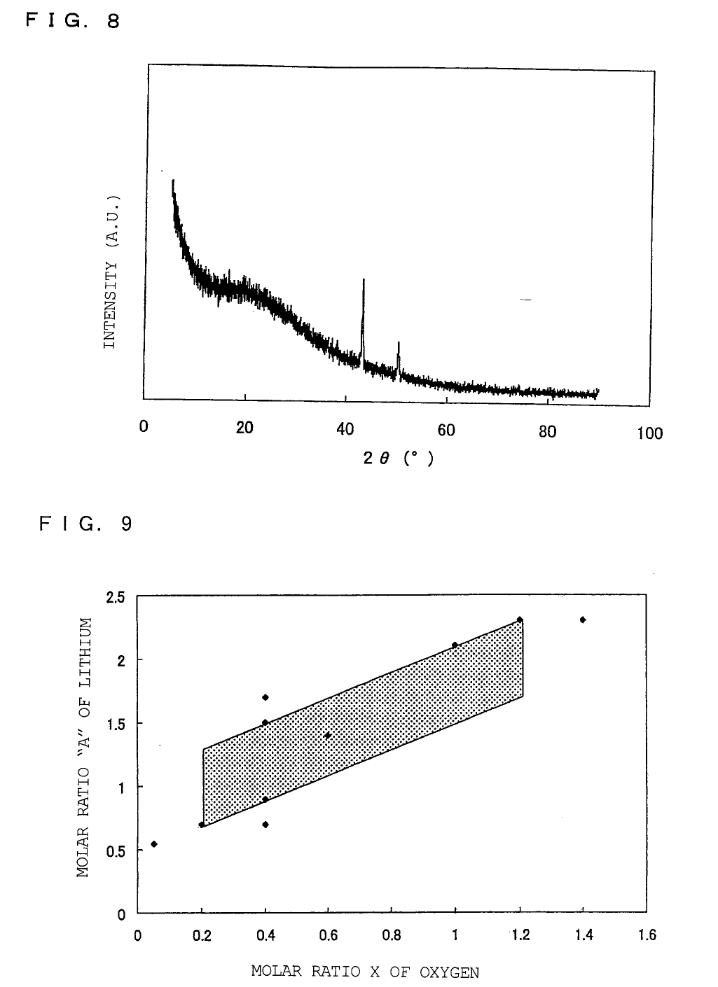

### BRIEF DESCRIPTION OF THE DRAWINGS

[FIG. 1] A longitudinal cross sectional view schematically showing a negative electrode for a lithium ion secondary battery according to one embodiment of the present invention.

[FIG. 2] A schematic view showing a vapor deposition apparatus to be used for forming an active material precursor layer on a current collector.

[FIG. 3] A schematic view showing a sputtering apparatus used for forming an active material precursor layer on a current collector.

[FIG. 4] A schematic view showing a sputtering apparatus used for vapor-depositing lithium on an active material precursor layer.

[FIG. 5] A view schematically showing a longitudinal cross section of a cylindrical battery fabricated in Examples.

[FIG. 6] A SEM observation photograph of a surface of an active material precursor layer, on which lithium is to be deposited, of Negative Electrode 1 fabricated in Example 1.

[FIG. 7] A SEM observation photograph of a surface of Negative Electrode 1 fabricated in Example 1.

[FIG. 8] A graph showing a result of analysis of Negative Electrode 1 fabricated in Example 1 by an XRD analytical method.

[FIG. 9] A graph showing a relation between a molar ratio x of oxygen and a molar ratio “a” of lithium in a negative electrode active material included in a lithium ion secondary battery according to one embodiment of the present invention, and an area in which the molar ratio x of oxygen and the molar ratio “a” of lithium are appropriate.

### BEST MODE FOR CARRYING OUT THE INVENTION

The present invention is based on the following findings discovered by the present inventors. The present inventors have found that by vapor-depositing lithium on a layer including an active material precursor containing silicon and oxygen to cause the lithium to react with the active material precursor, diffusion paths for lithium are formed in the surface of the active material precursor, and as a result, the reaction resistance is reduced and thus the initial charge time can be shortened. In addition, the present inventors have found an appropriate amount of lithium with which the battery capacity can be maximized, according to the ratio between silicon and oxygen.

FIG. 1 schematically shows a longitudinal cross sectional view of a negative electrode according to one embodiment of the present invention.

The negative electrode of FIG. 1 comprises a negative electrode current collector 12 and a negative electrode active material layer 11 carried on the negative electrode current collector 12. The negative electrode active material layer 11 includes a negative electrode active material containing silicon, oxygen and lithium. The negative electrode active material layer may or may not include a binder.

Examples of the material for the negative electrode current collector include copper, nickel and stainless steel. The surface of the negative electrode current collector may be flat or rough. In the case where the surface of the negative electrode current collector is rough, a preferred surface roughness Ra is 0.5 to 2.5 μm. The active material layer to be formed on the negative electrode current collector may be in a film state or in a columnar state.

The negative electrode active material containing silicon, oxygen and lithium may be formed by vapor-depositing lithium on a layer including an active material precursor containing silicon and oxygen (hereinafter referred to as an active material precursor layer) to cause reaction between the active material precursor and lithium. In this case, lithium is driven off as vapor deposition atoms and lands on the active material precursor layer. It is considered that a high energy of the lithium driven off facilitates the reaction between the active material precursor and lithium.

As described above, the negative electrode active material containing silicon, oxygen and lithium is formed through a solid phase reaction between the active material precursor and lithium. This negative electrode active material has diffusion paths for lithium at an atomic level. By virtue of the formation of diffusion paths for lithium in the active material, the diffusion resistance of lithium in the negative electrode active material is reduced. Furthermore, by virtue of the formation of bonding between silicon and lithium, the electron conductivity of the negative electrode active material improves, resulting in a decrease of reaction resistance. This makes it possible to shorten the charge time during initial charge.

The mechanism of a solid phase reaction between lithium and the active material precursor is unclear at present, but the studies conducted by the present inventors have revealed that lithium and an active material precursor layer are allowed to react through a solid phase reaction without the necessity of an electrolyte interposed therebetween. Specifically, when lithium is diffused throughout the active material precursor, the lithium enters the bonding network of silicon and oxygen, the network having blocked the diffusion of lithium. This presumably results in the formation in an atomic level of diffusion paths that permit lithium to enter and exit, and as a result, the reaction resistance during the reaction of initial charge and discharge can be reduced.

In addition, the diffusion of lithium improves the electron conductivity of the active material. For such reasons as described above, it is considered that the reaction resistance during initial charge is reduced, and thus the charge time can be shortened.

The negative electrode of FIG. 1 has cracks 13 uniformly formed throughout the entire layer of the negative electrode active material layer. The cracks 13 are presumably formed in the following manner. That is, as described above, the negative electrode active material layer 11 is formed by vapor-depositing lithium on the active material precursor layer. During this process, the active material precursor and the lithium react to form a negative electrode active material layer, and the active material layer thus formed has a thickness greater by approximately 20 to 30% than the thickness of the active material precursor layer. This forms cracks throughout the entire active material layer.

Since the negative electrode active material layer has cracks, the area of the interface between the active material layer and the electrolyte is increased, and thus the resistance of battery reaction can be reduced.

In the negative electrode active material layer, it is preferable that the cracks are formed throughout the entire active material, for example, in a mesh form. More specifically, in the negative electrode active material layer, it is preferable that the cracks are formed such that the active material particles are divided into small units having a form of polygon.

To the contrary, for example, as in Patent Document 2, in the case where a silicon oxide and lithium are vapor-deposited simultaneously, the silicon oxide and the lithium react upon evaporating, to form Si—Li or Li—O. Since only a small amount of lithium is added to the active material layer in order to supplement the irreversible capacity, the active material layer thus formed is mainly composed of the silicon oxide and contains a small amount of SiLi and LiO. In such an active material layer, lithium is not diffused into the layer composed of a silicon oxide until a battery reaction occurs, and after the lithium is diffused, diffusion paths for lithium are formed at an atomic level. For this reason, it is considered that the reaction resistance becomes high during the initial charge only. It should be noted that cracks will not be formed in the active material layer that has been formed by simultaneous deposition of a silicon oxide and lithium.

Further, studies conducted by the present inventors have revealed the following: when the negative electrode active material containing silicon, oxygen and lithium is represented by the general formula LiₐSiOₓ, it is required that the relation between a molar ratio “a” of lithium and a molar ratio x of oxygen relative to silicon be 0.5≦a−x≦1.1 and 0.2≦x≦1.2.

Specifically, if the molar ratio x of oxygen is increased, the efficiency during initial charge and discharge is reduced, the irreversible capacity is increased and the battery capacity is reduced. In order to prevent the reduction in battery capacity, the molar ratio “a” of lithium in the active material must be increased. However, when the molar ratio “a” is too large, the charge capacity is decreased depending on the type of the positive electrode active material, resulting in a decrease in battery capacity. For this reason, the molar ratio “a” of lithium and the molar ratio x of oxygen in the active material need to satisfy the relation as described above.

When the molar ratio x of oxygen is less than 0.2, the expansion rate during charge becomes high, and the expansion stress causes deformation of the electrode plate, peeling off of the active material layer, and the like. On the other hand, when the molar ratio x of oxygen is greater than 1.2, the capacity is reduced, making it impossible to take full advantage of the property of silicon having a high capacity.

When the difference a−x between the molar ratio “a” of lithium and the molar ratio x of oxygen is less than 0.5, the amount of lithium that supplements the irreversible capacity of the negative electrode becomes insufficient, making it impossible to fully utilize the advantage of high capacity. When the difference a−x is greater than 1.1, the lithium is excessively present relative to the irreversible capacity of the negative electrode, and thus the chargeable capacity is reduced. As a result, the battery capacity is reduced.

It is preferable that in the resultant negative electrode active material layer, on the surface thereof, lithium oxide or lithium carbonate is formed. Such lithium oxide or lithium carbonate is formed, for example, through a chemical reaction in which the lithium remaining on the surface of the active material layer is combined with atmospheric oxygen or carbon dioxide.

Such lithium oxide or lithium carbonate functions as a coating film in the interface between the active material layer and the electrolyte in an assembled battery. Specifically, such lithium oxide or lithium carbonate has an effect of inhibiting formation of a coating film derived from the components of the electrolyte, on the active material layer during charge and discharge.

In the active material layer 11, the negative electrode active material may be amorphous, or in a cluster state or a microcrystalline state. Among these, it is preferable that the active material is amorphous. If a region of microcrystalline silicon is present in the active material layer, the crystalline structure changes considerably when the silicon reacts with lithium, which may result in a poor reversibility and thus significantly reduce the cycle characteristics. In contrast, if the negative electrode active material layer is amorphous, the structure thereof is comparatively hard to decompose, and excellent cycle characteristics can be obtained.

Next, a method for fabricating a negative electrode for a lithium ion secondary battery of the present invention will be described.

The negative electrode for a lithium ion secondary battery of the present invention may be fabricated, for example, by forming an active material precursor layer on a current collector and then vapor-depositing lithium on the active material precursor layer.

First, a method for fabricating an active material precursor layer will be described.

The active material precursor layer may be fabricated, for example, by a method including a step of: while moving a current collector in a vacuum chamber continuously within a predetermined range, by means of a sputtering method or a vapor deposition method that uses elementary silicon as an evaporation source, allowing silicon atoms forming the elementary silicon to pass though an oxygen atmosphere, thereby to supply the silicon atoms on the current collector.

The active material precursor layer may be formed on the negative electrode current collector using, for example, a vapor deposition apparatus or a sputtering apparatus as shown in FIG. 2 or FIG. 3.

The vapor deposition apparatus of FIG. 2 has a current collector feeding roller 22, a can roller 23, a winding roller 24, and a silicon target 25 disposed in a vacuum chamber (not shown). In the vapor deposition apparatus of FIG. 2, a continuous length of current collector 21 moves from the feeding roller 22 through a roller 26, the can roller 23 and a roller 27 toward the winding roller 24.

Between the current collector 21 on the can roller 23 and the silicon target 25, an oxygen atmosphere is present. While the current collector 21 is moved by the rotation of the can roller 23 and the silicon target is heated, silicon atoms are deposited on the current collector 21 on the can roller 23. In this process, the silicon atoms are evaporated and pass through the oxygen atmosphere. As a result, during the time when the current collector 21 is present on the can roller 23, an active material precursor layer containing silicon and oxygen is formed gradually on the current collector.

The target may be heated, for example, with an electron bean (EB) heater (not shown).

In order to prevent the evaporated atoms from being vapor-depositing on a portion other than the current collector, a shield plate 28 for shielding the evaporated atoms is disposed between the target 25 and the can roller 23.

The oxygen atmosphere is composed of, for example, oxygen gas. In the apparatus of FIG. 2, in order to allow an oxygen atmosphere to be present between the target and the current collector, for example, oxygen gas is ejected from a nozzle 29 in the direction indicated by an arrow.

The oxygen concentration in the region through which silicon atoms pass can be adjusted by controlling the flow rate of the oxygen gas, the pressure reduction rate in the vacuum chamber, etc. Therefore, the molar ratio x of oxygen in the active material precursor layer can be changed. The molar ratio x of oxygen contained in the active material precursor layer is adjusted so that 0.2≦x≦1.2.

The thickness of the active material precursor layer can be controlled by changing the moving speed of the current collector and/or the deposition speed of silicon atoms.

The formation of the active material precursor layer may be carried out while the current collector is moved or the current collector is stopped. In the case where the active material precursor layer is formed while the current collector is stopped, an active material precursor layer is formed first in a predetermined area on the current collector. After the formation of the active material precursor layer is completed, the current collector is moved so that an active material precursor layer is formed in another area on the current collector. By repeating these operations, an active material precursor layer can be formed on the current collector.

It is desirable that the thickness T of the active material precursor layer per one face of the current collector is 0.5 μm≦T≦30 μm. When the thickness of the active material precursor layer is less than 0.5 μm, a sufficient battery capacity cannot be obtained. When the thickness of the active material precursor layer is more than 30 μm, the expansion rate of the active material layer during charge is increased and the cycle characteristics are reduced.

It is preferable that the thickness of the active material layer per one face of the current collector is 0.5 μm to 50 μm. Here, the thickness of the active material layer is a thickness of the negative electrode active material layer in a discharge state.

A sputtering apparatus may be used in place of the vapor deposition apparatus as described above to form an active material precursor layer.

FIG. 3 shows a schematic view of a sputtering apparatus used for forming an active material precursor layer. In FIG. 3, the same components as in FIG. 2 are denoted by the same numerals. As in the vapor deposition apparatus of FIG. 2, the formation of an active material layer on the current collector is carried out in a vacuum chamber (not shown).

In the sputtering apparatus of FIG. 3, a sputtering gas such as argon is converted into a plasma by a high frequency power supply 31, and the sputtering gas converted into a plasma is used to evaporate a silicon target 32.

As in the case of the vapor deposition apparatus of FIG. 2, an oxygen atmosphere is present between the silicon target 32 and the current collector 21.

As in the same manner as described above, the evaporated silicon atoms pass through the oxygen atmosphere and deposit on the current collector together with oxygen. In this process, as in the same manner as described above, the molar ratio x of oxygen contained in the active material precursor layer can be changed so that 0.2≦x≦1.2 by changing the oxygen concentration contained in the oxygen atmosphere.

The thickness of the active material precursor layer can be adjusted, as in the same manner as described above, by changing the moving speed of the current collector and/or the deposition speed of the silicon atoms. As in the same manner as described above, the active material precursor layer does not always need to be formed while the current collector is moved.

By using the fabrication method as described above, it is possible to form an active material precursor layer on the current collector by changing the molar ratio x of oxygen as desired. Further, the formation of an active material precursor layer can be carried out in a single vacuum chamber using inexpensive elementary silicon as a target. Therefore, it is possible to produce an active material precursor layer at low costs and in a highly effective manner.

Next, lithium is vapor-deposited on the active material precursor layer.

FIG. 4 shows a schematic view of a vapor deposition apparatus used for vapor-depositing lithium. In FIG. 4, the same components as in FIG. 2 are denoted by the same numerals. As in the vapor deposition apparatus of FIG. 2, the vapor deposition of lithium is carried out in a vacuum chamber (not shown).

In the vapor deposition apparatus of FIG. 4, an electrode plate 41 comprising a current collector and an active material precursor layer formed on both faces of the current collector is continuously moved by the rotation of the can roller 23. While the electrode plate is moved, a lithium target 42 is heated and evaporated with a heater (not shown) disposed in the vicinity of the target, so that the evaporated lithium atoms are vapor-deposited on the layer including an active material precursor. This causes a solid phase reaction between the active material precursor and the lithium, whereby a layer of an active material containing silicon, oxygen and lithium can be obtained. At this time, the vapor-deposited lithium is diffused in the active material precursor layer, resulting in a uniform presence of lithium in the active material layer. Consequently, the vapor-deposited lithium does not remain as a layer, on the active material layer.

The amount of vapor-deposited lithium in this process (i.e., the molar ratio “a” of lithium in the active material layer) is adjusted so that 0.5≦a−x≦1.1 according to the amount of oxygen contained in the active material precursor layer.

In addition, the amount of vapor-deposited lithium can be changed by changing the moving speed of the current collector or the deposition speed of lithium atoms.

In this case also, the active material precursor layer does not always need to be formed while the current collector is moved.

It is preferable that the vapor deposition of lithium on the active material precursor layer is carried out in an atmosphere composed of an inert gas. Specifically, in the case of vapor-depositing lithium on the active material precursor layer, it is preferable that an inert gas is present at least between the lithium target 42 and the electrode plate 41. This is because that if oxygen gas and/or carbon dioxide gas remains between the target and the electrode plate, the evaporated lithium may be combined with these gases before it is deposited.

As for the inert gas, for example, a pipe 43 is used to supply the inert gas to the vicinity of the lithium target 42 at a constant flow rate. By doing this, it is possible not only to prevent oxidation of lithium, but also to supply the inert gas between the target 42 and the electrode plate 41. The inert gas is exemplified, for example, by argon gas.

It is preferable that the active material precursor layer is heated at 50 to 200° C. while lithium is vapor-deposited, or the active material precursor layer with the lithium vapor-deposited thereon is heated at 50 to 200° C. after the vapor deposition of lithium is completed. The active material precursor layer may be heated by heating the can roller 23 with which the electrode plate including the active material precursor layer is in contact to 50 to 200° C. By setting the heating temperature at 50° C. or more, the speed of solid phase reaction between the active material precursor layer and lithium can be accelerated. As a result, for example, in the case where the active material precursor layer is heated while lithium is vapor-deposited, the lithium can be allowed to be present uniformly in the active material precursor layer substantially at the same time when the lithium is deposited on the active material precursor layer. However, when the heating temperature is higher than 200° C., metallic atoms forming the current collector are diffused in the active material layer, the capacity may be decreased.

The present invention will be hereinafter described with reference to Examples.

### EXAMPLES

### Example 1

### Battery 1-1

### (i) Fabrication of Positive Electrode

100 parts by weight of lithium cobaltate (LiCoO₂) having a mean particle size of 5 μm and 3 parts by weight of acetylene black serving as a conductive agent were mixed. To the resultant mixture, an N-methyl-2-pyrrolidone (NMP) solution of polyvinylidene fluoride (PVdF) serving as a binder was added and mixed to prepare a paste-like positive electrode material mixture. The NMP solution of PVdF was mixed so that the added amount of PVdF was 4 parts by weight.

This positive electrode material mixture was applied to both faces of a current collector sheet made of aluminum foil, then dried, and rolled, whereby a positive electrode was obtained.

### (ii) Fabrication of Negative Electrode

The fabrication method of a negative electrode will be described later.

(iii) Fabrication of Battery

The positive electrode and the negative electrode thus fabricated were used to fabricate a 17500 size cylindrical battery as shown in FIG. 5.

A positive electrode 51, a negative electrode 52 and a separator 53 interposed between the positive electrode and the negative electrode were wound into a spiral shape to fabricate an electrode assembly. The electrode assembly was housed in a battery case 58 made of nickel-plated iron.

One end of a positive electrode lead 54 made of aluminum is connected with the positive electrode 51 and the other end of the positive electrode lead 54 was connected with a positive electrode terminal 60. Specifically, the positive electrode terminal 60 was bonded to a conductive member disposed in the center of a sealing plate 59 made of resin, and the other end of the positive electrode lead 54 was connected with the back face of the conductive member.

One end of a negative electrode lead 55 made of nickel was connected with the negative electrode 52 and the other end of the negative electrode lead 55 was connected with the bottom of the battery case 58.

An upper insulating plate 56 and a lower insulating plate 57 were arranged in the upper part and the lower part of the electrode assembly, respectively.

Subsequently, a predetermined amount of electrolyte was injected into the battery case 58. The electrolyte was prepared by dissolving LiPF₆ in a mixture solvent containing ethylene carbonate and ethyl methyl carbonate at a volume ratio of 1:3 so that the concentration of LiPF₆ was 1 mol/L.

Finally, the opening of the battery case 58 was hermetically sealed with the sealing plate 59, whereby a battery was finished.

Next, a fabrication method of a negative electrode will be described. The fabrication of a negative electrode was carried out using a vapor deposition apparatus as shown in FIG. 2, that is, a vapor deposition apparatus (available from ULVAC, Inc.) having an EB heater (not shown), which was provided with a current collector feeding device, a can roller and a winding device, and the like.

The fabrication of a negative electrode was carried out essentially in such a manner as described above.

For the negative electrode current collector, an electrolytic copper foil (available from Furukawa Circuit Foil Co., Ltd.) having a width of 10 cm, a thickness of 35 μm and a length of 50 m was used. The surface roughness Ra of the electrolytic copper foil was 1.5 μm.

For the gas composing the oxygen atmosphere, oxygen gas having a purity of 99.7% (available from Nippon Sanso Corporation) was used. The oxygen gas was ejected from the nozzle 29 at a flow rate of 60 sccm. The nozzle 29 was connected with a pipe introduced to the interior of the vacuum chamber from an oxygen bomb through a mass flow controller. The pressure in the vacuum chamber with oxygen gas introduced thereto was 1.5×10⁻⁴ torr.

For the target 25, single crystals of silicon having a purity of 99.9999% (available from Shin-Etsu Chemical Co., Ltd.) were used.

The copper foil serving as the current collector was set on the feeding roller 22 and sent from the feeding roller 22 through the can roller 23 to the winding roller 24 having a reel where the copper foil was wound. The copper foil was moved at a speed of 5 cm per minute. The temperature of the can roller 23 was 20° C.

The single crystals of silicon were evaporated so that the evaporated silicon atoms passed through the oxygen atmosphere and then deposited on the current collector, whereby an active material precursor layer was formed.

The accelerating voltage of the electron beam irradiated to the target 25 of single crystals of silicon was set at −8 kV, and the emission of the electron beam was set at 300 mA.

Subsequently, in the same manner as described above, an active material precursor layer was formed also on the other face of the current collector. The thickness per one face of the active material precursor layer was 10 μm

Next, lithium was vapor-deposited on the active material precursor layers using a vapor deposition apparatus as shown in FIG. 4, that is, a vapor deposition apparatus having a heater, which was provided with a current collector feeding device, a can roller and a winding device, and the like.

For the target, lithium having a purity of 99.97% (available from The Honjo Chemical Corporation) was used. For the inert gas, argon gas was used. The argon gas was passed through the pipe 43 and ejected at a flow rate of 20 sccm. The pressure in the vacuum chamber with the argon gas introduced therein was 2×10⁻⁴ torr.

First, the electrode plate 41 comprising the active material precursor layer formed on both faces of the current collector was set on the feeding roller 22 and sent from the feeding roller 22 through the can roller 23 to the winding roller 24 having a reel where the current collector was wound. The electrode plate 41 was moved at a speed of 5 cm per minute. The temperature of the can roller 23 was 80° C.

The output of the heater for heating lithium was set at 40 W and the argon gas was used a carrier gas, to deposit lithium on one of the active material precursor layers. On the other one of the active material precursor layers, lithium was deposited in the same manner to obtain a negative electrode plate.

Finally, the negative electrode plate thus obtained was cut into a predetermined size, whereby a negative electrode was obtained. The negative electrode thus obtained was referred to as Negative Electrode 1.

The surface of the electrode plate on which lithium is to be deposited (i.e., the surface of the active material precursor layer) and the surface of Negative Electrode 1 were observed with a scanning electron microscope (SEM). The results are shown in FIG. 6 and FIG. 7.

As shown in FIG. 6, on the surface of the active material precursor layer, clustered broccoli-like grown units (active material particles) are observed.

When lithium is vapor-deposited on the surface of this active material precursor layer to cause a reaction between the active material precursor and the lithium, on the surface of the resultant active material layer, as shown in FIG. 7, the broccoli-like units separately expand and cracks are formed on the surface thereof. As such, the lithium is not present as a thin film, but present as a negative electrode active material as represented by LiₐSiOₓ formed through a solid phase reaction with the active material precursor.

A mean size of the diameter of the foregoing units (active material particles) after the reaction with lithium is preferably 1 to 30 μm.

A white particulate residue as observed in FIG. 7 is lithium oxide or lithium carbonate. This is a product of a reaction between the lithium unreacted with silicon, and atmospheric carbon hydroxide, etc.

Further, Negative Electrode 1 was analyzed by an X-ray diffraction method (XRD) using Kα ray of Cu. The results are shown in FIG. 8.

As a result of the identification, only copper was detected, and in the obtained chart, a distinctive peak of 2θ was not found from 10° to 35°. Based on the foregoing, it is considered that the negative electrode active material is amorphous.

Subsequently, the electrode plate before lithium is vapor-deposited on the active material precursor layer was subjected to an X-ray fluorescence spectrometry to determine a ratio between silicon and oxygen. Further, Negative Electrode 1 was subjected to an ICP emission spectrometry to determine a ratio between lithium and silicon. The results indicated that the negative electrode active material was represented by the formula Li_{1.4}SiO_{0.6}.

In Negative Electrode 1, the thickness of the active material layer per one face of the current collector was 13 μm.

### (Battery 1-2)

The case where the active material precursor containing silicon and oxygen is a powder will be hereinafter described.

75 parts by weight of an active material precursor powder (SiO_{1.1} available from Sumitomo Titanium Corporation), 15 parts by weight of acetylene black (AB) serving as a conductive agent, and an aqueous dispersion of styrene butadiene rubber (SBR) serving as a binder were mixed to prepare a paste-like negative electrode material mixture. Here, the aqueous dispersion of SBR was mixed so that the added amount of SBR was 10 parts by weight.

This negative electrode material mixture was applied to both faces of a current collector sheet made of copper foil, and then dried. Thereafter the sheet with the negative electrode active material mixture was rolled so that the thickness of the active material layer containing the active material precursor per one face of the current collector was 30 μm, whereby an electrode plate was obtained.

Subsequently, while the electrode plate thus obtained was send at a speed of 4 cm per minute, lithium was vapor-deposited on the active material layer. In such a manner, a negative electrode plate was obtained. The negative electrode plate thus obtained was cut into a predetermined size, whereby Negative Electrode 2 was obtained.

Negative Electrode 2 thus obtained was used to fabricate Battery 1-2 in the same manner as Battery 1-1. The thickness of the active material layer per one face of the current collector was 0.7 times as large as that of the positive electrode active material layer of Battery 1-1.

Negative Electrode 2 was analyzed in the same manner as Negative Electrode 1 was analyzed. The results indicated that the negative electrode active material included in Negative Electrode 2 was represented by Li_{1.6}SiO_{1.1}.

In Negative Electrode 2, the thickness of the active material layer per one face of the current collector was 33 μm. In this case, the thickness of the active material layer was only approximately 10% thicker than the thickness of the material mixture layer including an active material precursor. It is considered that this was caused by: that the acetylene black contained in the active material layer slightly absorbed the expansion of the active material layer; that since a SiO powder was used, the gaps in the powder absorbed the expansion; and the like.

Moreover, in the case where lithium was vapor-deposited on the material mixture layer, diffusion paths for lithium were formed, and cracks were produced throughout the entire active material layer.

### (Comparative Battery 1)

For comparison, a layer including an active material containing silicon, oxygen and lithium was formed on the current collector in the following manner.

An apparatus (not shown) obtained by modifying the vapor deposition apparatus shown in FIG. 2 to include a lithium target and a heater for heating the lithium target disposed in the vicinity of the silicon target 25, was used. Moreover, silicon monoxide (available from Kojundo Chemical Laboratory Co., Ltd.) was used in place of the silicon. The accelerating voltage of the electron beam irradiated to the silicon monoxide was set at −8 kV, the emission thereof was set at 30 mA, and the output of the heater for heating the lithium target was set at 40 W. Then the simultaneous vapor deposition of silicon monoxide and lithium was carried out to fabricate Negative Electrode 3. Here, oxygen was not introduced. Negative Electrode 3 was analyzed in the same manner as described above. The results indicated that the composition of the negative electrode active material was Li_{1.8}SiO.

The thickness of the active material layer per one face of the current collector was 18 μm.

The negative electrode thus obtained was used to fabricate Comparative Battery 1 in the same manner as Battery 1-1 was fabricated.

It should be noted that if simultaneous vapor deposition of silicon and lithium was carried out while oxygen is introduced, the lithium is preferentially combined with the oxygen, resulting in the formation of a mixture layer of lithium oxide and silicon. This makes it impossible to reduce the irreversible capacity. For this reason, in the case of the method of simultaneous vapor deposition of all elements, the silicon monoxide target must be used, and disadvantageously, only an active material having a certain ratio between silicon and oxygen can be produced. Moreover, in this case, the lithium is not diffused in the layer composed of silicon monoxide until a battery reaction occurs, and after the lithium is diffused, diffusion paths for lithium are formed at an atomic level. It is considered therefore that the reaction resistance becomes high during initial charge only.

### [Evaluation]

### (Initial Charge Time, Initial Charge/Discharge Efficiency, and Initial Capacity)

Battery 1-1 was charged at a current of 40 mA until the battery voltage reached 4.2 V at an ambient temperature of 25° C. The length of time taken for this charge (initial charge time) was measured.

After allowed to stand for 20 minutes, the battery after charge was discharged at a current of 40 mA until the battery voltage reduced to 2.5 V.

Such a charge/discharge cycle was performed twice.

The discharge capacity at the first cycle relative to the charge capacity at the first cycle was determined as a percentage, which was referred to as an initial charge/discharge efficiency. The discharge capacity at the second cycle was referred to as an initial capacity. The results thus obtained are shown in Table 1.

With respect to Battery 1-2, the initial charge time, the initial charge/discharge efficiency and the initial capacity were determined in the same manner as in Battery 1-1. The results thus obtained are shown in Table 1.

Comparative Battery 1 was charged at a current of 40 mA until the battery voltage reached 4.2 V at an ambient temperature of 25° C. After this charge, the battery capacity of Comparative Battery 1 was half or less of the positive electrode capacity. For this reason, Comparative Battery 1 was charged again, in which it was subjected to a constant voltage charge with a cut-off current value of 5 mA. The conditions for discharge were the same as those in Battery 1-1.

The initial charge time, the initial charge/discharge efficiency and the initial capacity were determined in the same manner as in Battery 1-1. The results thus obtained are shown in Table. 1.

TABLE 1

| | | Initial | |
|---|---|---|---|
| | Initial charge | charge/discharge | |
| | time | efficiency | Initial capacity |
| | (hour) | (%) | (mAh) |
| Battery 1-1 | 6.2 | 95 | 250 |
| Battery 1-2 | 5.7 | 96 | 172 |
| Com. Battery 1 | 10 | 95 | 245 |

Table 1 shows that in Battery 1-1, the initial charge time is short and the resistance in the battery reaction during initial charge is small. Moreover, the results of Battery 1-2 indicate that an effect similar to that in the case of Battery 1-1 will be obtained in the case where the active material layer is formed from a material mixture layer containing an active material precursor powder.

Comparative Battery 1 had a same level of discharge capacity and initial charge/discharge efficiency. However, Comparative Battery 1, when charged at the same current value as in Battery 1-1, could not complete the charge, and required a long period of time for the initial charge. It is considered that this was because the reaction resistance during initial charge was high.

It is considered that the reaction resistance during initial state of Battery 1-1 was low because of the following reason. That is, in the negative electrode of Battery 1-1, after an active material precursor layer was formed, lithium was vapor-deposited on the active material precursor layer, whereby an active material layer was formed. Consequently, diffusion paths for lithium were formed in the negative electrode active material. Thereafter, the negative electrode active material layer expanded to form cracks on the surface thereof, which presumably increased the area of interface between the negative electrode active material layer and the electrolyte and thus decreased the reaction resistance.

Further as in Battery 1-2, even when the negative electrode active material was a powder, it is presumed that diffusion paths for lithium were formed in the negative electrode active material by vapor-depositing lithium thereon as in the case of the negative electrode of Battery 1-1.

### Example 2

Next, effective ranges of the molar ratio x of oxygen and the molar ratio “a” of lithium were examined. In this experiment, a vapor deposition apparatus as shown in FIG. 2 was used, the flow rate of oxygen gas to be introduced into the vacuum chamber was changed, and the oxygen ratio in the active material precursor layer was changed.

### (Comparative Battery 2-1)

An active material precursor layer was formed on both faces of the current collector in the same manner as in Battery 1-1 except that the flow rate of oxygen gas was set at 5 sccm, whereby an electrode plate was obtained. The thickness of the active material precursor layer was 10 μm. The thickness of the active material precursor layer of other batteries fabricated in this Example was also 10 μm. The pressure in the vacuum chamber with oxygen gas introduced thereto was 8×10⁻⁵ torr.

Thereafter, while the electrode plate thus obtained was sent at a speed of 9.7 cm per minute, lithium was vapor-deposited on the active material precursor layer. Battery 2-1 was fabricated in the same manner as Battery 1-1 except the above. The thickness of the active material layer per one face of the negative electrode current collector was 12 μm. In the positive electrode, the thickness of the active material layer per one face of the current collector was 1.2 times as large as that of the positive electrode active material layer of Battery 1-1.

### (Battery 2-2)

An active material precursor layer was formed on both faces of the current collector in the same manner as in Battery 1-1 except that the flow rate of oxygen gas was set at 20 sccm, whereby an electrode plate was obtained. The pressure in the vacuum chamber with oxygen gas introduced thereto was 1.2×10⁻⁴ torr.

Thereafter, while the electrode plate thus obtained was sent at a speed of 8.3 cm per minute, lithium was vapor-deposited on the active material precursor layer. Battery 2-2 was fabricated in the same manner as Battery 1-1 except the above. The thickness of the active material layer per one face of the negative electrode current collector was 13 μm. In the positive electrode, the thickness of the active material layer per one face of the current collector was 1.1 times as large as that of the positive electrode active material layer of Battery 1-1.

### (Battery 2-3)

An active material precursor layer was formed on both faces of the current collector in the same manner as in Battery 1-1 except that the flow rate of oxygen gas was set at 40 sccm, whereby an electrode plate was obtained. The pressure in the vacuum chamber with oxygen gas introduced thereto was 1.4×10⁻⁴ torr.

Thereafter, while the electrode plate thus obtained was sent at a speed of 7.1 cm per minute, lithium was vapor-deposited on the active material precursor layer. Battery 2-3 was fabricated in the same manner as Battery 1-1 except the above. The thickness of the active material layer per one face of the negative electrode current collector was 14 μm.

### (Battery 2-4)

An active material precursor layer was formed on both faces of the current collector in the same manner as in Battery 1-1 except that the flow rate of oxygen gas was set at 100 sccm, whereby an electrode plate was obtained. The pressure in the vacuum chamber with oxygen gas introduced thereto was 2.0×10⁻⁴ torr.

Thereafter, while the electrode plate thus obtained was sent at a speed of 3.9 cm per minute, lithium was vapor-deposited on the active material precursor layer. Battery 2-4 was fabricated in the same manner as Battery 1-1 except the above. The thickness of the active material layer per one face of the negative electrode current collector was 14 μm. In the positive electrode, the thickness of the active material layer per one face of the current collector was 0.8 times as large as that of the positive electrode active material layer of Battery 1-1. The battery thus fabricated was referred to as Battery 2-4.

### (Battery 2-5)

An active material precursor layer was formed on both faces of the current collector in the same manner as in Battery 1-1 except that the emission of the electron beam was set at 280 mA, the flow rate of oxygen gas was set at 100 sccm, and the sending speed of the current collector was set at 4 cm per minute, whereby an electrode plate was obtained. The pressure in the vacuum chamber with oxygen gas introduced thereto was 2.0×10⁻⁴ torr.

Thereafter, while the electrode plate thus obtained was sent at a speed of 3.8 cm per minute, lithium was vapor-deposited on the active material precursor layer. Battery 2-5 was fabricated in the same manner as Battery 1-1 except the above. The thickness of the active material layer per one face of the negative electrode current collector was 13 μm. In the positive electrode, the thickness of the active material layer per one face of the current collector was 0.6 times as large as that of the positive electrode active material layer of Battery 1-1.

### (Battery 2-6)

An active material precursor layer was formed on both faces of the current collector in the same manner as in Battery 1-1 except that the flow rate of oxygen gas was set at 40 sccm, whereby an electrode plate was obtained. The pressure in the vacuum chamber with oxygen gas introduced thereto was 1.4×10⁻⁴ torr.

Thereafter, while the electrode plate thus obtained was sent at a speed of 4.3 cm per minute, lithium was vapor-deposited on the active material precursor layer. Battery 2-6 was fabricated in the same manner as Battery 1-1 except the above. The thickness of the active material layer per one face of the negative electrode current collector was 15 μm.

### (Comparative Battery 2-7)

An active material precursor layer was formed on both faces of the current collector in the same manner as in Battery 1-1 except that the emission of the electron beam was set at 260 mA, the flow rate of oxygen gas was set at 100 sccm, and the sending speed of the current collector was set at 3 cm per minute, whereby an electrode plate was obtained. The pressure in the vacuum chamber with oxygen gas introduced thereto was 2.0×10⁻⁴ torr.

Thereafter, while the electrode plate thus obtained was sent at a speed of 4.1 cm per minute, lithium was vapor-deposited on the active material precursor layer. Comparative Battery 2-7 was fabricated in the same manner as Battery 1-1 except the above. The thickness of the active material layer per one face of the negative electrode current collector was 11 μm. In the positive electrode, the thickness of the active material layer per one face of the current collector was 0.4 times as large as that of the positive electrode active material layer of Battery 1-1.

### (Comparative Battery 2-8)

An active material precursor layer was formed on both faces of the current collector in the same manner as in Battery 1-1 except that the flow rate of oxygen gas was set at 40 sccm, whereby an electrode plate was obtained. The pressure in the vacuum chamber with oxygen gas introduced thereto was 1.4×10⁻⁴ torr.

Thereafter, while the electrode plate thus obtained was sent at a speed of 9.1 cm per minute, lithium was vapor-deposited on the active material precursor layer. Comparative Battery 2-8 was fabricated in the same manner as Battery 1-1 except the above. The thickness of the active material layer per one face of the negative electrode current collector was 11 μm.

### (Comparative Battery 2-9)

An active material precursor layer was formed on both faces of the current collector in the same manner as in Battery 1-1 except that the flow rate of oxygen gas was set at 40 sccm, whereby an electrode plate was obtained. The pressure in the vacuum chamber with oxygen gas introduced thereto was 1.4×10⁻⁴ torr.

Thereafter, while the electrode plate thus obtained was sent at a speed of 3.8 cm per minute, lithium was vapor-deposited on the active material precursor layer. Comparative Battery 2-9 was fabricated in the same manner as Battery 1-1 except the above. The thickness of the active material layer per one face of the negative electrode current collector was 16 μm.

Negative electrodes of Batteries 2-1 to 2-9 were subjected to element analysis in the same manner as in Example 1. The results thus obtained are summarized in Table 2.

TABLE 2

| | Molar ratio x | Molar ratio | |
|---|---|---|---|
| | of oxygen | “a” of lithium | a − x |
| Com. Battery 2-1 | 0.05 | 0.55 | 0.5 |
| Battery 2-2 | 0.2 | 0.7 | 0.5 |
| Battery 2-3 | 0.4 | 0.9 | 0.5 |
| Battery 2-4 | 1 | 2.1 | 1.1 |
| Battery 2-5 | 1.2 | 2.3 | 1.1 |
| Battery 2-6 | 0.4 | 1.5 | 1.1 |
| Com. Battery 2-7 | 1.4 | 2.3 | 0.9 |
| Com. Battery 2-8 | 0.4 | 0.7 | 0.3 |
| Com. Battery 2-9 | 0.4 | 1.7 | 1.3 |

### [Evaluation]

### (Initial Charge/Discharge Efficiency and Initial Capacity)

With respect to Batteries 2-1 to 2-9, the initial charge/discharge efficiency and the initial capacity were determined in the same manner as in the foregoing Battery 1-1. The results are shown in Table 3.

### (Capacity Retention Rate)

The capacity retention rate of these batteries was measured as follows.

The batteries were charged at a current of 40 mA until the battery voltage reached 4.2 V at an ambient temperature of 25° C. After allowed to stand for 20 minutes, the batteries after charge were discharged at a current of 40 mA until the battery voltage reduced to 2.5 V. This charge/discharge cycle was performed 100 times. The discharge capacity at the 100th cycle relative to the initial capacity was determined as a percentage. The value thus determined was referred to as a capacity retention rate. The results are shown in Table 3.

TABLE 3

| | Initial | | Capacity |
|---|---|---|---|
| | charge/discharge | | retention rate |
| | efficiency | Initial capacity | after 100 cycles |
| | (%) | (mAh) | (%) |
| Com. Battery 2-1 | 97 | 280 | 55 |
| Battery 2-2 | 96 | 279 | 71 |
| Battery 2-3 | 93 | 260 | 82 |
| Battery 2-4 | 97 | 215 | 89 |
| Battery 2-5 | 97 | 160 | 88 |
| Battery 2-6 | 97 | 270 | 90 |
| Com. Battery 2-7 | 97 | 100 | 90 |
| Com. Battery 2-8 | 81 | 140 | 90 |
| Com. Battery 2-9 | 97 | 105 | 92 |

Table 3 indicates that by vapor-depositing an appropriate amount of lithium according to the ratio of oxygen, a battery having a high initial charge/discharge efficiency and a high capacity can be obtained.

On the other hand, the results of Battery 2-8 show that in the case where the difference a−x between the molar ratio “a” of lithium and the molar ratio x of oxygen was less than 0.5, the initial charge/discharge efficiency was slightly reduced. Presumably, this was because that the amount of supplemented lithium was small relative to the irreversible capacity.

Moreover, the results of Battery 2-9 show that in the case where the difference a−x was greater than 1.1, the discharge capacity was decreased. Presumably, this was because that the amount of lithium contained in the negative electrode was too large, and hence the chargeable capacity of the positive electrode was decreased.

As is shown in Table 2 and Table 3, the smaller the molar ratio x of oxygen was, the more the capacity retention rate after 100 cycles was reduced. Moreover, from the results of Comparative Battery 2-1, it was found that the molar ratio x of oxygen was smaller than 0.2, the capacity retention rate was extremely reduced.

Conversely, as the molar ratio x of oxygen was increased, the initial-state capacity tended to be reduced. Moreover, from the results of Batteries 2-7 to 2-9, it was found that when the molar ratio x of oxygen was greater than 1.2, the initial capacity was considerably reduced.

Based on the foregoing results, it can be concluded that it is appropriate that the molar ratio “a” of lithium and the molar ratio x of oxygen satisfy 0.5≦a−x≦1.1 and 0.2≦x≦1.2.

In addition, the relation between the molar ratio “a” of lithium and the molar ratio x of oxygen as examined in Example 2 was shown by plotting in FIG. 9. In FIG. 9, the shaded area represents an area in which the molar ratio “a” and the molar ratio x are preferable.

### Example 3

In this Example, the temperatures of an active material precursor layer during vapor deposition of lithium were examined.

A vapor deposition apparatus as shown in FIG. 2 was used to form an active material precursor layer on the current collector first. Thereafter, a vapor deposition apparatus as shown in FIG. 4 was used, in which the can roller was heated to heat the active material precursor layer to various temperatures. Under the condition in which the active material precursor layer was heated, lithium was vapor-deposited on the active material precursor layer, whereby a negative electrode was fabricated. Such a negative electrode was used to fabricate a battery and the characteristics of the battery were checked to determine an optimum temperature for heating.

### (Battery 3-1)

Battery 3-1 was fabricated in the same manner as Battery 1-1 except that the temperature of the can roller was set at 20° C.

### (Battery 3-2)

Battery 3-2 was fabricated in the same manner as Battery 1-1 except that the temperature of the can roller was set at 50° C.

### (Battery 3-3)

Battery 3-3 was fabricated in the same manner as Battery 1-1 except that the temperature of the can roller was set at 200° C.

### (Battery 3-4)

Battery 3-4 was fabricated in the same manner as battery 1-1 except that the temperature of the can roller was set at 300° C.

During the preparation of a negative electrode active material used in the foregoing Batteries 3-1 to 3-4, the flow rate of oxygen, the energy for evaporating silicon, the energy for evaporating lithium, and the like were adjusted so that the composition of the negative electrode active material was represented by Li_{1.4}SiO_{0.6}.

### [Evaluation]

The surface of the negative electrode of Batteries 3-1 to 3-4 was observed with a scanning electron microscope (SEM) to check the residual amount of lithium. The results are shown in FIG. 4.

### (Initial Charge/Discharge Efficiency and Initial Capacity)

With respect to Batteries 3-1 to 3-4, the initial charge/discharge efficiency and the initial capacity were measured in the same manner as in Battery 1-1. The results are shown in Table 4.

TABLE 4

| | | | Initial | |
|---|---|---|---|---|
| | Temperature | | charge/ | |
| | of can | | discharge | Initial |
| | roller | | efficiency | capacity |
| | (° C.) | SEM observation | (%) | (mAh) |
| Battery 3-1 | 20 | Residual amount | 90 | 230 |
| | | of Li: Large | | |
| Battery 3-2 | 50 | Residual amount | 95 | 242 |
| | | of Li: Small | | |
| Battery 3-3 | 200 | Residual amount | 96 | 240 |
| | | of Li: Small | | |
| Battery 3-4 | 300 | Residual amount | 96 | 150 |
| | | of Li: Small | | |

From the results of Battery 3-1 in Table 4, it was found that in the case where the heating temperature was 20° C., the residual amount of lithium was large, indicating that unreacted lithium was left. Moreover, in Battery 3-1, the initial charge/discharge efficiency was slightly reduced. Such unreacted lithium is oxidized immediately after the chamber was opened to air, and transformed to an inert lithium oxide or lithium carbonate that does not react with the active material precursor. Presumably, for this reason, a sufficient amount of lithium was not supplemented to the active material layer, and hence the initial charge/discharge efficiency was slightly reduced.

From the results of Table 3-4, it was found that in the case where the heating temperature was 300° C., the initial capacity was considerably reduced. Presumably, this was because that the active material precursor layer and part of copper atoms forming the current collector were diffused to each other, and hence SiCu that does not contribute to the charge/discharge capacity was formed.

Based on the foregoing results, it is found that it is desirable that the heating temperature of the active material precursor layer be set within the range of 50° C. to 200° C.

It should be noted that also in the case where after lithium is vapor-deposited on the active material precursor layer, the active material precursor layer with lithium vapor-deposited thereon is heated, it is desirable that the heating temperature is 50 to 200° C. as in the foregoing case.

### Example 4

Next, vapor deposition apparatuses as shown in FIG. 2 and FIG. 4 were used and the sending speed of the current collector was changed to form active material precursor layers having various thicknesses. The effective ranges of the thickness of the active material precursor layers were examined.

### (Battery 4-1)

An active material precursor layer was formed on both faces of the current collector in the same manner as in Battery 1-1 except that the sending speed of the current collector was set at 100 cm per minute and the thickness of the active material precursor layer per one face of the current collector was adjusted to 0.5 μm, whereby an electrode plate was obtained.

Subsequently, while the electrode plate thus obtained was sent at a speed of 100 cm per minute, lithium was vapor-deposited on the active material precursor layer. Battery 4-1 was fabricated in the same manner as Battery 1-1 except the above. The thickness of the active material layer per one face of the negative electrode current collector was 0.7 μm. In the positive electrode, the thickness of the active material layer per one face of the current collector was one eighths of that of the positive electrode active material layer of Battery 1-1.

The negative electrode included in Battery 4-1 was analyzed in the same manner as in the case of the foregoing Negative Electrode 1. As a result, it was found that the negative electrode active material was represented by Li_{1.4}SiO_{0.6}.

### (Battery 4-2)

An active material precursor layer was formed on both faces of the current collector in the same manner as in Battery 1-1 except that the sending speed of the current collector was set at 2.5 cm per minute and the thickness of the active material precursor layer per one face of the current collector was adjusted to 20 μm, whereby an electrode plate was obtained.

Subsequently, while the electrode plate thus obtained was sent at a speed of 2.5 cm per minute, lithium was vapor-deposited on the active material precursor layer. Battery 4-2 was fabricated in the same manner as Battery 1-1 except the above. The thickness of the active material layer per one face of the negative electrode current collector was 27 μm. In the positive electrode, the thickness of the active material layer per one face of the current collector was 1.2 times as large as that of the positive electrode active material layer of Battery 1-1.

The negative electrode included in Battery 4-2 was analyzed in the same manner as in the case of the foregoing Negative Electrode 1. As a result, it was found that the negative electrode active material was represented by Li_{1.4}SiO_{0.6}.

### (Battery 4-3)

An active material precursor layer was formed on both faces of the current collector in the same manner as in Battery 1-1 except that the sending speed of the current collector was set at 1.7 cm per minute and the thickness of the active material precursor layer per one face of the current collector was adjusted to 30 μm, whereby an electrode plate was obtained.

Subsequently, while the electrode plate thus obtained was sent at a speed of 1.7 cm per minute, lithium was vapor-deposited on the active material precursor layer. Battery 4-3 was fabricated in the same manner as Battery 1-1 except the above. The thickness of the active material layer per one face of the negative electrode current collector was 40 μm. In the positive electrode, the thickness of the active material layer per one face of the current collector was 1.5 times as large as that of the positive electrode active material layer of Battery 1-1.

The negative electrode included in Battery 4-3 was analyzed in the same manner as in the case of the foregoing Negative Electrode 1. As a result, it was found that the negative electrode active material was represented by Li_{1.4}SiO_{0.6}.

### (Battery 4-4)

An active material precursor layer was formed on both faces of the current collector in the same manner as in Battery 1-1 except that the sending speed of the current collector was set at 1.4 cm per minute and the thickness of the active material precursor layer per one face of the current collector was adjusted to 35 μm, whereby an electrode plate was obtained.

Subsequently, while the electrode plate thus obtained was sent at a speed of 1.4 cm per minute, lithium was vapor-deposited on the active material precursor layer. Battery 4-4 was fabricated in the same manner as Battery 1-1 except the above. The thickness of the active material layer per one face of the negative electrode current collector was 47 μm. In the positive electrode, the thickness of the active material layer per one face of the current collector was twice as large as that of the positive electrode active material layer of Battery 1-1.

The negative electrode included in Battery 4-4 was analyzed in the same manner as in the case of the foregoing Negative Electrode 1. As a result, it was found that the negative electrode active material was represented by Li_{1.4}SiO_{0.6}.

### (Initial Charge/Discharge Efficiency and Initial Capacity)

The initial charge/discharge efficiency and the initial capacity of Batteries 4-1 to 4-4 were measured in the same manner as in the foregoing Battery 1-1. The results are shown in Table 5.

### (Capacity Retention Rate)

The capacity retention rate of Batteries 4-1 to 4-4 was measured in the same manner as described above. The results are shown in Table 5. The thickness of the active material layer per one face of the current collector is also shown in Table 5.

TABLE 5

| | Thickness of active | Thickness of active | Initial charge/ | | |
|---|---|---|---|---|---|
| | material precursor | material layer per | discharge | Initial | Capacity retention |
| | layer per one face of | one face of current | efficiency | capacity | rate after 100 |
| | current collector (μm) | collector (μm) | (%) | (mAh) | cycles (%) |
| Battery 4-1 | 0.5 | 0.7 | 96 | 95 | 93 |
| Battery 4-2 | 20 | 27 | 94 | 305 | 81 |
| Battery 4-3 | 30 | 40 | 93 | 332 | 75 |
| Battery 4-4 | 35 | 47 | 91 | 346 | 68 |

As is shown in Table 5, in the negative electrode, the more the thickness of the active material precursor layer per one face of the current collector was increased, the more the cycle characteristics were reduced. It was revealed that assuming that the capacity retention rate after 100 cycles is 70% or more is a criterion, a desirable thickness of the active material precursor layer per one face of the current collector was 30 μm or less.

In the case where the sending speed of the current collector is set at 100 cm per minute or more, the thickness of the active material precursor layer can be formed so that the thickness thereof is thinner than 0.5 μm. However, when the thickness of the negative electrode active material layer is thin, the thickness of the positive electrode active material layer must be made thin accordingly. It is difficult to form a thin positive electrode active material layer with a production method as described above. Moreover, the battery capacity is significantly decreased, and thus the advantage of increased capacity due to silicon cannot be obtained.

However, in particular, in the case of a thin battery, this is effective.

In the case of Battery 4-1 in which the thickness of the active material precursor layer was 0.5 μm, the capacity was low but the initial charge/discharge efficiency was high. Therefore, Battery 4-1 is promising as a battery required to have a high output.

In this Example, the thickness of the current collector was 35 μm as that of Battery 1-1. In the case where the thickness of the active material precursor layer per one face of the current collector is 0.5 μm (Battery 4-1), the thickness of the current collector becomes thicker than necessary, compared with that of the active material layer. Consequently, the volume of the active material layer that can be inserted into the battery case is decreased. For this reason, the capacity was low.

It is preferable that the thickness of the active material layer per one face of the current collector is 0.5 to 50 μm

### Example 5

In this Example, a sputtering apparatus was used as a means for forming an active material precursor layer.

### (Battery 5-1)

An active material precursor layer was formed using a sputtering apparatus as shown in FIG. 3, that is, the sputtering apparatus (available from ULVAC, Inc.) in which a current collector feeding device, a can roller and a winding device, and the like are provided in the interior of the vacuum chamber (not shown).

In this case also, basically, the active material precursor layer was formed in the manner as described above.

For the current collector, an electrolytic copper foil (available from Furukawa Circuit Foil Co., Ltd.) having a width of 10 cm, a thickness of 35 μm and a length of 50 m was used. This copper foil was set on the feeding roller 22 and sent from the feeding roller 22 through the can roller 23 to the winding roller 24 having an empty reel where the copper foil was wound. The copper foil was sent at a speed of 0.1 cm per minute.

For a sputtering gas, argon gas having a purity of 99.999% (available from Nippon Sanso Corporation) was used. The flow rate of the argon gas was set at 100 sccm.

For the target 32, single crystals of silicon having a purity of 99.9999% (available from Shin-Etsu Chemical Co., Ltd.) were used. The output of the high frequency power supply 31 during the sputtering of the target 32 was set at 2 kW.

For the gas composing an oxygen atmosphere, oxygen gas having a purity of 99.7% (available from Nippon Sanso Corporation) was used. The flow rate of oxygen ejected from the nozzle 29 was set at 1 sccm. The nozzle 29 was connected with a pipe introduced to the interior of the vacuum chamber (not shown) from an oxygen bomb through a mass flow controller.

The pressure in the vacuum chamber with argon and oxygen introduced thereto was 1 torr. Presumably, the partial pressure of oxygen gas was approximately 0.01 torr in view of the balance between the flow rate of oxygen gas and the flow rate of argon gas.

Under the conditions as described above, an active material precursor layer was formed on both faces of the current collector, whereby an electrode plate was obtained. The thickness of the active material precursor layer per one face of the current collector was 10 μm.

The electrode plate formed as described above was used, to fabricate Battery 5-1 in the same manner as Battery 1-1. The thickness of the active material layer per one face of the negative electrode current collector was 13 μm.

The results of measurement in the same manner as described above indicated that the composition of the negative electrode active material was Li_{1.4}SiO_{0.6}.

The initial capacity and the initial charge/discharge efficiency of Battery 5-1 were measured in the same manner as in Battery 1-1. The results are shown in Table 6. The results of Battery 1-1 are also shown in Table 6.

TABLE 6

| | Initial | |
|---|---|---|
| | charge/discharge | |
| | efficiency | Initial capacity |
| | (%) | (mAh) |
| Battery 1-1 | 95 | 250 |
| Battery 5-1 | 95 | 245 |

Comparison of the results of Battery 1-1 with the results of Battery 5-1 confirmed that regardless of whether a vapor deposition apparatus is used or a sputtering apparatus is used, negative electrodes having an equivalent performance can be fabricated.

In the foregoing Examples, for the positive electrode active material, lithium cobalt oxide was used. However, other positive electrode active materials can be used with similar effects.

For the electrolyte, a liquid electrolyte was used. However, a solid electrolyte or a gelled electrolyte can be used with similar effects, in place of the liquid electrolyte. The gelled electrolyte can be formed, in general, of a liquid electrolyte and a host polymer for retaining the same.

### INDUSTRIAL APPLICABILITY

According to the present invention, it is possible to provide a negative electrode for a high capacity lithium ion secondary battery having a shortened initial charge time. Batteries including such a negative electrode are useful, for example, as a power supply for portable electronic equipment.

1. A negative electrode for a lithium ion secondary battery comprising a current collector and an active material layer carried on said current collector, wherein
said active material layer includes an active material represented by the general formula: LiₐSiOₓ where 0.5≦a−x≦1.1 and 0.2≦x≦1.2; and
said active material is obtainable by vapor-depositing lithium on a layer including an active material precursor containing silicon and oxygen to cause reaction between said active material precursor and said lithium.

2. The negative electrode for a lithium ion secondary battery in accordance with claim 1, wherein said active material layer has cracks throughout the entire layer thereof.

3. The negative electrode for a lithium ion secondary battery in accordance with claim 1, wherein lithium oxide or lithium carbonate is present on the surface of said active material layer.

4. The negative electrode for a lithium ion secondary battery in accordance with claim 1, wherein a thickness T of said layer including an active material precursor is 0.5 μm≦T≦30 μm.

5. The negative electrode for a lithium ion secondary battery in accordance with claim 1, wherein a thickness of said active material layer is 0.5 μm to 50 μm.

6. A method for producing a negative electrode for a lithium ion secondary battery comprising the steps of:
(A) forming a layer including an active material precursor containing silicon and oxygen on a current collector; and
(B) vapor-depositing lithium on said layer including an active material precursor to cause reaction between said active material precursor and lithium.

7. The method for producing a negative electrode for a lithium ion secondary battery in accordance with claim 6, wherein in said step (B), while lithium is vapor-deposited on said layer including an active material precursor, said layer including an active material precursor is heated to 50° C. to 200° C., thereby to cause reaction between said active material precursor and lithium.

8. The method for producing a negative electrode for a lithium ion secondary battery in accordance with claim 6, wherein in said step (B), after lithium is vapor-deposited on said layer including an active material precursor, said layer including an active material precursor, on which lithium is vapor-deposited, is heated to 50° C. to 200° C., thereby to cause reaction between said active material precursor and lithium.

9. The method for producing a negative electrode for a lithium ion secondary battery in accordance with claim 6, wherein vapor deposition of said lithium is performed using a vapor deposition method or a sputtering method.

10. The method for producing a negative electrode for a lithium ion secondary battery in accordance with claim 6, wherein in said step (B), lithium is vapor-deposited on said layer including an active material precursor in an atmosphere composed of an inert gas.

11. A lithium ion secondary battery comprising a positive electrode, the negative electrode in accordance with claim 1, a separator interposed between said positive electrode and said negative electrode, and an electrolyte.

12. A negative electrode for a lithium ion secondary battery comprising a current collector and an active material layer carried on said current collector, wherein
said active material layer includes an active material containing silicon, oxygen and lithium and is represented by the general formula: LiₐSiOₓ
where 0.5≦a−x≦1.1 and 0.2≦x≦1.2;
said active material layer has cracks throughout the entire layer thereof.
